(19) United States
(12) Patent Application Publication
(10) Pub. No.: US 2026/0153657 A1
(43) Pub. Date: Jun. 4, 2026

(54) ARTICLES INCLUDING A MULTILAYER OPTICAL FILM AND FLUOROPOLYMER LAYERS, TRANSFER ARTICLES, AND METHODS OF MAKING SAME

(71) Applicant: 3M INNOVATIVE PROPERTIES COMPANY, St. Paul, MN (US)

(72) Inventors: Kevin W. Gotrik, Hudson, WI (US); Stephen P. Maki, North St. Paul, MN (US); Scott J. Jones, Woodbury, MN (US); Brandon R. Pietz, St. Paul, MN (US); Caleb T. Nelson, McKinney, TX (US); David J. Rowe, Roseville, MN (US); Timothy J. Hebrink, Scandia, MN (US)

(21) Appl. No.: 18/706,553

(22) PCT Filed: Nov. 21, 2022
(86) PCT No.: PCT/IB2022/061227

§ 371 Date: May 1, 2024

Related U.S. Application Data
(60) Provisional application No. 63/293,376, filed on Dec. 23, 2021.
(60) Provisional application No. 63/309,663, filed on Feb. 14, 2022.

(51) Int. Cl. G02B 5/20; B32B 17/10; B32B 27/08; B32B 27/32; B32B 37/00; B32B 37/14; B32B 37/15; B32B 38/10; G02B 5/28

(52) U.S. Cl. CPC G02B 5/208; B32B 17/10; B32B 27/08; B32B 27/322; B32B 37/025; B32B 37/144; B32B 37/153; B32B 38/10; G02B 5/283; B32B 2250/02; B32B 2255/10; B32B 2255/20; B32B 2255/28; B32B 2307/418; B32B 2307/42; B32B 2315/08; B32B 2327/12; B32B 2551/00

(57) ABSTRACT

Articles are provided including a first fluoropolymer substrate having a tetrafluoroethylene (TFE) content of >10 to <55 mole %; a multilayer optical film disposed on the first substrate; and a second fluoropolymer substrate having a TFE content of >55 mole % disposed on the first fluoropolymer substrate opposite the multilayer optical film. The multilayer optical film is composed of alternating first and second layers of high refractive index material and low refractive index material. The multilayer optical film transmits incident light in a wavelength range from at least 400 nanometers to 700 nanometers. Often, the multilayer optical films reflects or absorbs certain wavelength bands within a wavelength range of 190 to 320 nanometers. Transfer articles are also provided including a release layer including a metal layer or a doped semiconductor layer; an acrylate layer disposed on a major surface of the release layer; and a multilayer optical film disposed on a major surface of the acrylate layer opposite the release layer. The disclosure further provides methods of making articles and transfer articles.

### FIELD

The present disclosure generally relates to articles including multilayer optical films that transmit, reflect, and/or absorb selected wavelengths of ultraviolet (UV) light.

### BACKGROUND

Ultraviolet (UV) light is useful, for example, for initiating free radical reaction chemistries used in coatings, adhesives, and polymeric materials. Ultraviolet light is also useful, for example, for disinfecting surfaces, filters, bandages, membranes, articles, air, and liquids (e.g., water). Examples where UVC (i.e., ultraviolet C includes wavelengths in a range from 100 nanometers to 280 nanometers) disinfection could be applied include medical offices and supplies, airplane restrooms, hospital rooms and surgical equipment, schools, air and water purification, and consumer applications (e.g., toothbrush and cell phone disinfection). Prevention of infection and spread of disease, especially in high-risk environments and populations, has become increasingly more critical as pathogens mutate and develop antibiotic resistance. The availability and speed of global human travel elevates risks of rapidly developed epidemics/pandemics. Air and water disinfection is paramount to human health and preventing infectious disease. Benefits of UVC disinfection include touch-free application, and the mechanical disruption of cells at non-gene specific targets is unlikely to be overcome by pathogens via mutation to develop resistance. Surfaces being disinfected with ultraviolet light other than metal, ceramic, or glass surfaces will need protection from ultra-violet light. UVC irradiation can be applied to effectively inactivate or kill prokaryotic and eukaryotic microorganisms alike, including bacteria, viruses, fungi and molds. Bacterial strains with developed resistance to one or more antibiotics are also susceptible to UVC light. Some examples of pathogens of heightened interest include hospital acquired infections (e.g., C. diff, E. coli, MRSA, Klebsiella, influenza, mycobacteria, and enterobacteria), water and soil borne infections (e.g., giardia, legionella, and campylobacter) and airborne infections (e.g., influenza, pneumonia, and tuberculosis).

UV light, however, can also be harmful to people and animals in varying degrees. For example, UV light sources that emit 400 nm to 500 nm wavelength light may cause long term damage to the eyes.

### SUMMARY

In a first aspect, an article is provided. The article includes a first substrate composed of a fluoropolymer having greater than 10 mole % content of tetrafluoroethylene (TFE) and less than 55 mole % content of TFE; a multilayer optical film disposed on a first major surface of the first substrate; and a second substrate disposed on a second major surface of the first substrate opposite the multilayer optical film, the second substrate composed of a fluoropolymer having greater than 55 mole % content of TFE. The multilayer optical film is composed of alternating first and second layers of high refractive index material and low refractive index material, wherein the multilayer optical film transmits, at an incident light angle of at least one of 0°, 15°, 30°, 45°, 60°, or 75°, at least 30, 40, 50, 60, 70, 80, or 90 percent of incident light over at least a 30-nanometer wavelength bandwidth in a wavelength range from at least 400 nanometers to 700 nanometers.

In a second aspect, a transfer article is provided. The transfer article includes a release layer; an acrylate layer disposed on a major surface of the release layer; and a multilayer optical film disposed on a major surface of the acrylate layer opposite the release layer. The release layer includes a metal layer or a doped semiconductor layer. The multilayer optical film is composed of alternating first and second layers of high refractive index material and low refractive index material, wherein the multilayer optical film transmits, at an incident light angle of at least one of 0°, 15°, 30°, 45°, 60°, or 75°, at least 30, 40, 50, 60, 70, 80, or 90 percent of incident light over at least a 30-nanometer wavelength bandwidth in a wavelength range from at least 400 nanometers to 700 nanometers.

In a third aspect, a method of making an article is provided. The method includes obtaining a transfer article according to the second aspect: removing the release layer from the transfer article; and laminating the multilayer optical film of the transfer article to a major surface of a third substrate comprised of a fluoropolymer having greater than 10 mole % content of TFE and less than 55 mole % content of TFE.

### BRIEF DESCRIPTION OF THE DRAWINGS

FIG. 1 is a schematic cross-sectional view of an exemplary article or transfer article preparable according to the present disclosure.

FIG. 2 is a schematic cross-sectional view of an article that includes buckling deformations and non-buckling regions.

FIG. 3 is a flow chart of an exemplary method of making an article, according to the present disclosure.

FIG. 4 is a schematic view of a vacuum coating system from each of a side view and a top view.

### DETAILED DESCRIPTION

### Glossary

As used herein, the term “polymer” will be understood to include homopolymers and copolymers, as well as polymers or copolymers that may be formed in a miscible blend, for example, by co-extrusion or by reaction, including transesterification. The terms “polymer” and “copolymer” also include both random and block copolymers.

As used herein, “fluoropolymer” refers to any organic polymer containing fluorine.

As used herein, “incident” with respect to light refers to the light falling on or striking a material.

As used herein, “radiation” refers to electromagnetic radiation unless otherwise specified.

As used herein, “absorption” refers to a material converting the energy of light radiation to internal energy.

As used herein, “absorb” with respect to wavelengths of light encompasses both absorption and scattering, as scattered light also eventually gets absorbed.

As used herein, “scattering” with respect to wavelengths of light refers to causing the light to depart from a straight path and travel in different directions with different intensities.

As used herein, “reflectance” is the measure of the proportion of light or other radiation striking a surface at normal incidence which is reflected off it. Reflectivity typically varies with wavelength and is reported as the percent of incident light that is reflected from a surface (0 percent—no reflected light, 100—all light reflected. Reflectivity and reflectance are used interchangeably herein.

As used herein, “reflective” and “reflectivity” refer to the property of reflecting light or radiation, especially reflectance as measured independently of the thickness of a material.

As used herein, “average reflectance” refers to reflectance averaged over a specified wavelength range.

As used herein, the term “absorbance” with respect to a quantitative measurement refers to the base 10 logarithm of a ratio of incident radiant power to transmitted radiant power through a material. The ratio may be described as the radiant flux received by the material divided by the radiant flux transmitted by the material. Absorbance (A) may be calculated based on transmittance (T) according to Equation 1:

$$A = - {log}_{10} T \qquad ( 1 )$$

Emissivity can be measured using infrared imaging radiometers with methods described in ASTM E1933-14 (2018) “Standard Practice for Measuring and Compensating for Emissivity Using Infrared Imaging Radiometers.”

Absorbance can be measured with methods described in ASTM E903-12 “Standard Test Method for Solar Absorptance, Reflectance, and Transmittance of Materials Using Integrating Spheres”. Absorbance measurements described herein were made by making transmission measurements as previously described and then calculating absorbance using Equation 1.

The term “release value” with reference to average peel force determined by the test for T-Peel Test Method or 180° Peel Test Method according to ASTM D1876-08 “Standard Test Method for Peel Resistance of Adhesives (T-Peel Test)”.

The term “substantially” with reference to a property or characteristic means that the property or characteristic is exhibited to a greater extent than the opposite of that property or characteristic is exhibited. For example, a substrate that is “substantially” transparent refers to a substrate that transmits more radiation (e.g., visible light) than it fails to transmit (e.g., absorbs and reflects). Thus, a substrate that transmits more than 50% of the visible light incident upon its surface is substantially transparent, but a substrate that transmits 50% or less of the visible light incident upon its surface is not substantially transparent. Concomitantly, a substrate that is “substantially” impermeable to radiation of a certain wavelength range blocks (e.g., absorbs and reflects) more than 50% of those wavelengths of radiation.

### Articles

In a first aspect, an article is provided. The article comprises:
a) a first substrate composed of a fluoropolymer having greater than 10 mole % content of tetrafluoroethylene (TFE) and less than 55 mole % content of TFE;
b) a multilayer optical film disposed on a first major surface of the first substrate, wherein the multilayer optical film is composed of alternating first and second layers of high refractive index material and low refractive index material, wherein the multilayer optical film transmits, at an incident light angle of at least one of 0°, 15°, 30°, 45°, 60°, or 75°, at least 30, 40, 50, 60, 70, 80, or 90 percent of incident light over at least a 30-nanometer wavelength bandwidth in a wavelength range from at least 400 nanometers to 700 nanometers; and
c) a second substrate disposed on a second major surface of the first substrate opposite the multilayer optical film, the second substrate composed of a fluoropolymer having greater than 55 mole % content of TFE.

Certain UVC light (e.g., having a wavelength in a range of 190 to 240 nanometers (nm)), is effective at neutralizing airborne virions at doses comparatively safe for human exposure, compared to UVA/UVB light. Most polymers, however, will discolor after prolonged exposure to UVC wavelengths. Ultraviolet light, in particular the ultraviolet radiation having wavelengths in a range from 280 nm to 400 nm, can induce degradation of plastics, which in turn results in color change and deterioration of optical and mechanical properties. Inhibition of photo-oxidative degradation is important, for instance, for outdoor applications wherein long-term durability is mandatory. The absorption of ultraviolet light by polyethylene terephthalates, for example, starts at around 360 nm, increases markedly below 320 nm, and is very pronounced at below 300 nm. Polyethylene naphthalates strongly absorb ultraviolet light in the 310 nm to 370 nm range, with an absorption tail extending to about 410 nm, and with absorption maxima occurring at 352 nm and 337 nm. Chain cleavage occurs in the presence of oxygen, and the predominant photooxidation products are carbon monoxide, carbon dioxide, and carboxylic acids. Besides the direct photolysis of the ester groups, consideration has to be given to oxidation reactions, which likewise form carbon dioxide via peroxide radicals.

There is thus a need for a material that is resistant to color change, optionally provides high reflectivity in the UVC wavelength range (e.g., to help recycle virion-destroying light), and is preferably visibly transparent to allow observation of any underlying colors and/or designs. Various fluoropolymers are color robust and visibly transparent but are not reflective in the UVC range. Sputter deposited metal-oxide multilayers can reflect UVC, but such deposition processes generate reactive oxygen radicals and high temperature, which have the potential to distort the fluoropolymer, cause chain scission, and possibly generate HF.

It has been discovered that an article can be prepared including a multilayer optical film including alternating first and second layers of high refractive index material and low refractive index material directly adhered to a fluoropolymer layer having intact molecular weight and polymer entanglement architecture. Methods for making such an article are described in detail below with respect to the third aspect. Briefly, a transfer article including the multilayer optical film is obtained and the multilayer optical film is laminated to a fluoropolymer substrate having TFE content of >10 mole % to <55 mole %. Transfer articles are described in detail below with respect to the second aspect. A fluoropolymer having such a TFE content has been unexpectedly discovered to successfully attach to multilayer optical films when laminated together instead of being required to be directly deposited on the fluoropolymer as the multilayer optical film is manufactured. For instance, in some embodiments, the fluoropolymer substrate and the multilayer optical film exhibit a peel force of 100 grams per inches (g/in) or greater. In contrast, a fluoropolymer substrate having a TFE content of 55 mole % or greater tends to not adhere to the multilayer optical film upon lamination.

As mentioned above, the first substrate is composed of a fluoropolymer having greater than 10 mole % content of TFE and less than 55 mole % content of TFE. Suitable exemplary fluoropolymers containing TFE monomer within this range include copolymers of tetrafluorethylene, hexafluoropropylene, and vinylidene fluoride (THV) under the trade designations “DYNEON THV 220,” “DYNEON THV 221,” “DYNEON THV 230,” “DYNEON THV 2030,” and “DYNEON THV 415” from Dyncon LLC, Oakdale, MN. In select embodiments, the first substrate comprises THV, such as a THV comprising a 39 mole % content of TFE (e.g., “DYNEON THV 220” or “DYNEON THV 221”). It is to be understood that a combination of each of the monomers that make up the copolymer provides a total mole % of 100.

A thickness of the first substrate is not particularly limited and can range from as low as a primer coating up to a self-supporting substrate, e.g., 50 nanometers (nm) or greater, 75 nm, 100 nm, 150 nm, 200 nm, 250 nm, 300 nm, 350 nm, 400 nm, 500 nm, 750 nm, 1.0 micrometer (μm), 1.5 μm, 2.0 μm, 2.5 μm, 3 μm, 4 μm, 5 μm, 7 μm, 10 μm, 12 μm, 15 μm, 17 μm, or 20 μm or greater; and 400 μm or less, 350 μm, 300 μm, 250 μm, 200 μm, 175 μm, 150 μm, 125 μm, 100 μm, 75 μm, 60 μm, 50 μm, 45 μm, 40 μm, 35 μm, 30 μm, 25 μm, 20 μm, or 15 μm or less.

As mentioned above, the second substrate is composed of a fluoropolymer having greater than 55 mole % content of TFE, such as 60 mole % or greater, 65, 70, 75, or 80 mole % or greater; and 90 mole % or less. Such a high TFE content imparts better scratch resistance and soiling resistance to the fluoropolymer substrate than exhibited by copolymers having lower TFE content. Suitable exemplary fluoropolymers containing TFE monomer within this range include copolymers of tetrafluorethylene, hexafluoropropylene, and vinylidene fluoride (THV) under the trade designations “DYNEON THV 500,” “DYNEON THV 610,” and “DYNEON THV 815” from Dyncon LLC, Oakdale, MN; a copolymer (FEP) comprising subunits derived from tetrafluoroethylene (TFE) and hexafluoropropylene (HFP) under the trade designations “CHEMFILM FEP-FG”, “CHEMFILM FEP-FS”, “CHEMFILM FEP-RF”, and “CHEMFILM FEP-WF” from Saint-Gobain (La Defense, France); and polytetrafluoroethylene (PTFE) under the trade designations “CHEMFILM T-100”, “CHEMFILM Flex Barriers LP01”, “CHEMFILM Flex Barriers FR01”, and “CHEMFILM Flex Barriers FR02” from Saint-Gobain (La Defense, France). In select embodiments, the second substrate comprises THV, such as a THV comprising a 72.5 mole % content of TFE (e.g., “DYNEON THV 815”).

A thickness of the second substrate can range from 50 nm or greater, 75 nm, 100 nm, 150 nm, 200 nm, 250 nm, 300 nm, 350 nm, 400 nm, 500 nm, 750 nm, 1 μm, 2 μm, 3 μm, 4 μm, 5 μm, 7 μm, 10 μm, 12 μm, 15 μm, 17 μm, or 20 μm or greater; and 400 μm or less, 350 μm, 300 μm, 250 μm, 200 μm, 175 μm, 150 μm, 125 μm, 100 μm, 75 μm, 60 μm, 50 μm, 45 μm, 40 μm, 35 μm, 30 μm, 25 μm, 20 μm, or 15 μm or less.

In some embodiments, the article further comprises a third substrate disposed on a major surface of the multilayer optical film opposite the first substrate, the third substrate composed of a fluoropolymer having a greater than 10 mole % content of TFE and less than 55 mole % content of TFE. The fluoropolymer of the third substrate is as described above with respect to the first substrate.

Advantageously, the first and second substrates tend to be strongly adhered to each other, particularly when the first substrate and the second substrate are formed via coextrusion. For instance, preferably the first and second substrates exhibit a peel force of greater than 100 g/in.

In some embodiments, the article further comprises a fourth substrate disposed on a major surface of either the multilayer optical film or the third substrate opposite the multilayer optical film when the third substrate is present. The fourth substrate is composed of glass or a fluoropolymer having a greater than 55 mole % content of TFE. Suitable glass for the fourth substrate either is pure quartz glass that transmits wavelengths in a range of 190 nm to 320 nm or is a doped glass that absorbs wavelengths in a range of 190 nm to 320 nm. The fluoropolymer of the fourth substrate is as described above with respect to the second substrate.

In addition to exhibiting some minimum wavelength transmission in the visible light range, depending on the application for the article, the multilayer optical film reflects, absorbs, and/or transmits certain UV wavelengths. For each wavelengths/wavelength ranges mentioned herein, it is to be understood that the multilayer optical film is exposed to incident light angle of at least one of 0°. 15°, 30°, 45°, 60°, or 75°. Further, it is to be understood that the percent of incident light absorbed refers to the amount absorbed integrated over a particular wavelength range (as opposed to the amount of a single wavelength that is absorbed).

In certain embodiments, the multilayer optical film reflects at least 50, 60, 70, 80, 90, or 95 percent of incident light over a reflection wavelength bandwidth of at least 30 nm in a wavelength range from at least 190 nm to 320 nm.

In certain embodiments, the multilayer optical film transmits at least 80, 85, 90, or 95 percent of incident light over a wavelength bandwidth of at least 30 nm in a wavelength range from at least 190 nm to 240 nm and reflects at least 50, 60, 70, 80, 90, or 95 percent of incident light over a reflection wavelength bandwidth of at least 30 nm in a wavelength range from at least 250 nm to 320 nm.

In certain embodiments, the multilayer optical film transmits at least 80, 85, 90, or 95 percent of incident light over a wavelength bandwidth of at least 30 nm in a wavelength range from at least 190 nm to 240 nm absorbs at least 50, 60, 70, 80, 90, or 95 percent of incident light over an absorption wavelength bandwidth of at least 30 nm in a wavelength range from at least 250 nm to 320 nm.

In certain embodiments, the multilayer optical film absorbs at least 50, 60, 70, 80, 90, or 95 percent of incident light over an absorption wavelength bandwidth of at least 30 nm in a wavelength range from at least 190 nm to 320 nm.

As indicated above, typically the absorption, transmission, and/or reflection is less than 100% of the total incident light. In most preferred embodiments, greater than 90 percent, 91, 92, 93, 94, 95, 96, 97, or 98 or greater, of incident light is absorbed, transmitted, and/or reflected. Wavelengths of light below 230 nm have not been found to be carcinogenic to human skin, thus the reflection of 190 nm to 230 nm by the multilayer optical film can assist in disinfection with less risk to humans in the vicinity. In each of the embodiments in which incident light within a wavelength range from at least 250 nm to 320 nm is reflected or absorbed, the article may be particularly suitable for use in environments where humans are present due to primarily transmitting the safer far UVC light through the article (e.g., 190 to 240 nm).

In embodiments in which the multilayer optical film absorbs wavelengths within the range of 190 nm to 320 nm, the multilayer optical film optionally comprises one or more of an ultraviolet radiation absorber, an ultraviolet radiation scatterer, a hindered amine light stabilizer, an anti-oxidant, or a combination thereof. Suitable ultraviolet radiation absorbers include titanium dioxide, zinc oxide, cesium dioxide, zirconium dioxide, or combinations thereof. These particular ultraviolet radiation absorbers tend to be stable to ultraviolet radiation in addition to absorbing the radiation. Suitable ultraviolet radiation absorbers further include a benzotriazole compound, a benzophenone compound, a triazine compound (e.g., including any combination thereof).

Some suitable ultraviolet radiation absorbers are red shifted UV absorbers (RUVA) which absorb at least 70% (in some embodiments, at least 80%, or even greater than 90%) of the UV light in the wavelength region from 180 nm to 400 nm. Typically, it is desirable if the RUVA is highly soluble in polymers of the multilayer optical film, highly absorptive, photo-permanent and thermally stable in the temperature range from 200° C. to 300° C.

RUVAs typically have enhanced spectral coverage in the long-wave UV region, enabling it to block the high wavelength UV light that can cause yellowing in polyesters. Typically, a RUVA loading level is 2-10 wt. %, based on the total weight of a multilayer optical film. One of the most effective RUVA is a benzotriazole compound, 5-trifluoromethyl-2-(2-hydroxy-3-alpha-cumyl-5-tert-octylphenyl)-2H-benzotriazole (available under the trade designation “CGL-0139” from BASF, Florham Park, NJ). Other exemplary benzotriazoles include 2-(2-hydroxy-3,5-di-alpha-cumylphehyl)-2H-benzotriazole, 5-chloro-2-(2-hydroxy-3-tert-butyl-5-methylphenyl)-2H-benzotiazole, 5-chloro-2-(2-hydroxy-3,5-di-tert-butylphenyl)-2H-benzotriazole, 2-(2-hydroxy-3,5-di-tert-amylphenyl)-2H-benzotriazole, 2-(2-hydroxy-3-alpha-cumyl-5-tert-octylphenyl)-2H-benzotriazole, 2-(3-tert-butyl-2-hydroxy-5-methylphenyl)-5-chloro-2H-benzotriazole. Further exemplary RUVAs includes 2(-4,6-diphenyl-1-3,5-triazin-2-yl)-5-hexyloxy-phenol. Other exemplary UV absorbers include those available from BASF under the trade designations “TINUVIN 1577.” “TINUVIN 900,” “TINUVIN 1600,” and “TINUVIN 777.” Other exemplary UV absorbers are available, for example, in a polyester master batch under the trade designation “TA07-07 MB” from Sukano Polymers Corporation, Dunkin, SC. An exemplary UV absorber for polymethylmethacrylate is a masterbatch available, for example, under the trade designation “TA11-10 MBO1” from Sukano Polymers Corporation. In addition, the UV absorbers can be used in combination with hindered amine light stabilizers (HALS) and anti-oxidants. Exemplary HALS include those available from BASF, under the trade designation “CHIMASSORB 944” and “TINUVIN 123.” Exemplary anti-oxidants include those obtained under the trade designations “IRGANOX 1010” and “ULTRANOX 626”, also available from BASF.

The multilayer optical film comprises multiple low/high index pairs of film layers, wherein each low/high index pair of layers has a combined optical thickness of ½ the center wavelength of the band it is designed to reflect. In certain embodiments, the refractive index difference between low/high index pairs is 0.1 or greater, 0.2, 0.3, 0.4, 0.5, 0.6, or 0.7 or greater; and 1.5 or less, 1.4, 1.3, 1.2, 1.1, 1.0, 0.9, or 0.8 or less. Stacks of such films are commonly referred to as quarterwave stacks. In some embodiments, different low/high index pairs of layers may have different combined optical thicknesses, such as where a broadband reflective optical film is desired. Materials employed in the multilayer optical films are preferably resistant to ultraviolet radiation. Many fluoropolymers and certain inorganic materials are resistant to ultraviolet radiation.

In some embodiments of the multilayer optical films described herein, the at least first optical layer comprises inorganic material (e.g., at least one of zirconium oxynitride, hafnia, alumina, magnesium oxide, yttrium oxide, lanthanum fluoride, or neodymium fluoride), and wherein the second optical layer comprises inorganic material (e.g., at least one of silica, aluminum fluoride, magnesium fluoride, calcium fluoride, silica alumina oxide, or alumina doped silica). Exemplary materials are available, for example, from Materion Corporation, Mayfield Heights, OH, and Umicore Corporation, Brussels, Belgium. In select embodiments, the high refractive index material is composed of ZrOₓN_{y}, HfO₂, TiO₂, or ZnO and the low refractive index material composed of SiO₂SiAlₓO_{y}, or MgF₂. With respect to the x and y values of ZrOₓN_{y}, one exemplary atomic ratio of Zr:O:N may be approximately 33:62:2 (with the remainder of about 3%, to get to 100% was atomic %, being carbon). Such a ratio is close to ZrO₂ due to the small amount of nitrogen present. Some representative refractive indices for certain materials at each of 250 nm and 510 nm is presented in the table below.

TABLE 1
Refractive Indices

| Material | n (250 nm) | n (510 nm) |
|---|---|---|
| ZrOₓN_{y} | 2.54 | 2.17 |
| HfO₂ | 2.05 | 1.85 |
| TiO2 | 2.44 | 2.43 |
| ZnO | 2.05 | 1.98 |
| SiO₂ | 1.51 | 1.46 |
| SiAlₓO_{y} | 1.57 | 1.50 |
| MgF₂ | 1.42 | 1.39 |

The layer thickness profile (layer thickness values) of multilayer optical films described herein reflecting at least 50 percent of incident UV light over a specified wavelength range can be adjusted to be approximately a linear profile with the first (thinnest) optical layers adjusted to have about a ¼ wave optical thickness (index times physical thickness) for 190 nm light and progressing to the thickest layers which would be adjusted to be about ¼ wave thick optical thickness for 240 nm light or 230 nm light.

Dielectric mirrors, with optical thin film stack designs comprised of alternating thin layers of inorganic dielectric materials with refractive index contrast, are particularly suited for this. In recent decades they are used for applications in UV, Visible, NIR and IR spectral regions. Depending upon the spectral region of interest, there are specific materials suitable for that region. Also, for coating these materials, one of two forms of physical vapor deposition (PVD) are used: evaporation or sputtering. Evaporated coatings rely upon heating the coating material (evaporant) to a temperature at which it evaporates. This is followed by condensation of the vapor upon a substrate. For evaporated dielectric mirror coatings, the electron-beam deposition process is most commonly used. Sputtered coatings use energetic gas ions to bombard a material (“target”) surface, ejecting atoms which then condense on the nearby substrate. Depending upon which coating method is used, and the settings used for that method, thin film coating rate and structure-property relationships will be strongly influenced. Ideally, coating rates should be high enough to allow acceptable process throughput and film performance, characterized as dense, low stress, void free, non-optically absorbing coated layers.

Exemplary embodiments can be designed to have peak reflectance at 222 nm, by both PVD methods. For example, coating discrete substrates by electron-beam deposition method, using HfO₂ as the high refractive index material and SiO₂ as the low refractive index material. Mirror design has alternating layers of “quarter wave optical thickness” (qwot) of each material, that are coated, layer by layer until, for example, after 11 layers the reflectance at 215 nm is >95%. The bandwidth of this reflection peak is around 50 nm. Quarter wave optical thickness is the design wavelength, here 215 nm, divided by 4, or 53.75 nm. Physical thickness of the high refractive index layers (HfO₂) is the quotient of qwot and refractive index of HfO₂ at 215 nm (2.35), or 23.2 nm. Physical thickness of the low refractive index layers (MgF₂), with 215 nm refractive index at 1.42, is 37.85 nm. Coating a thin film stack, then, which is comprised of alternating layers of HfO₂ and SiO₂ and designed to have peak reflectance at 215 nm begins by coating layer 1 HfO₂ at 23.2 nm. In electron beam deposition a four-hearth evaporation source is used. Each hearth is cone-shaped and 17 cm³ volume of HfO₂ chunks fill it. The magnetically deflected high voltage electron beam is raster scanned over the material surface as filament current of the beam is steadily, in a pre-programmed fashion, increased. Upon completion of the pre-programmed step the HfO₂ surface is heated to evaporation temperature, about 2500° C., and a source shutter opens, the HfO₂ vapor flux emerging from the source in a cosine-shaped distribution and condensing upon the substrate material above the source. For enhancement of coating uniformity, the substrate holders rotate during deposition. Upon reaching the prescribed coating thickness (23.2 nm) the filament current shuts off; the shutter closes and the HfO₂ material cools. For layer 2 the evaporation source is then rotated to a hearth containing chunks of MgF₂ and a similar pre-programmed heating process begins. Here, the MgF₂ surface temperature is about 950° C. when the source shutter opens and, upon reaching the prescribed coating thickness (37.85 nm), the filament current shuts off; the shutter closes and the HfO₂ material cools. This step-wise process is continued, layer by layer, until the total number of design layers is reached. With this optical design, as total layers are increased, from 3 to 11, the resulting peak reflectance increases accordingly, from 40% at 3 layers to >95% at 11 layers.

Optionally, multilayer optical films can be prepared in continuous roll to roll (R2R) fashion, using ZrON as the high refractive index material and SiO₂ as the low refractive index material. The optical design is the same type of thin film stack, alternating qwot layers of the two materials. For ZrON, with refractive index at 215 nm of 3.1, the physical thickness target was 17.3 nm. For SiO₂, here sputtered from an aluminum-doped silicon sputter target, with refractive index 1.61, the target thickness was 33.3 nm. Layer one ZrON is DC sputtered from a pure zirconium sputter target in a gas mixture of argon, oxygen and nitrogen. Whereas argon is the primary sputtering gas, oxygen and nitrogen levels are set to achieve transparency, low absorptance and high refractive index. The film roll transport initially starts at a pre-determined speed, and the sputter source power is ramped to full operating power, followed by introduction of the reactive gases and then achieving steady state condition. Depending upon the length of film to coat, the process continues until total footage is achieved. Here, as the sputter source is orthogonal to and wider than the film which is being coated, the uniformity of coating thickness is quite high. Upon reaching the desired length of coated film the reactive gases are set to zero and the target is sputtered to a pure Zr surface state. The film direction is next reversed and silicon (aluminum doped) rotary pair of sputter targets has AC frequency (40 kHz) power applied in an argon sputtering atmosphere. Upon reaching steady state, oxygen reactive gas is introduced to provide transparency and low refractive index. At the pre-determined process setting and line speed the second layer is coated over the length which was coated for layer one. Again, as these sputter sources are also orthogonal to and wider than the film being coated, the uniformity of coating thickness is quite high. After reaching the desired length of coated film the reactive oxygen is removed and the target is sputtered in argon to a pure silicon (aluminum doped) surface state. Layers three to five or seven or nine or eleven or thirteen, depending upon peak reflectance target, are coated in this sequence. Upon completion, the film roll is removed for post-processing.

For manufacturing of these inorganic coatings, the electron beam process is best suited for coating discrete parts. Though some chambers have demonstrated R2R film coating, the layer by layer coating sequence would still be necessary. For R2R sputtering of film, it is advantageous to use a sputtering system with multiple sources located around one, or perhaps two, coating drums. Here, for a thirteen layers optical stack design, a two, or even single, machine pass process, with alternating high and low refractive index layers coated sequentially, would be feasible. How many machine passes needed would be contingent upon machine design, cost, practicality of thirteen consecutive sources, and so forth. Additionally, coating rates would need to be matched to a single film line speed.

Often, the multilayer optical film reflects at an incident light angle of at least one of 0°, 15°, 30°, 45°, 60°, or 75°, at least 80 percent, 85, 90, 91, 92, 93, 94, 95, 96, 97, or at least 98 percent of incident ultraviolet light in a wavelength range from 190 nanometers to 230 nanometers. The selection of the material combinations used in creating the multilayer optical film depends, for example, upon the desired bandwidth that will be reflected. Higher refractive index differences between the first optical layer polymer and the second optical layer polymer create more optical power thus enabling more reflective bandwidth per pair of layers. The number of optical layers is selected to achieve the desired optical properties using the minimum number of layers for reasons of film thickness, flexibility and economy. In the case of reflective films such as mirrors, the number of optical layers is preferably less than about 21, 19, 17, 15, 13, or 11. The refractive index of zirconia is so high that a low number of optical layers is needed when zirconia or zirconia oxynitride is employed, such as 13 optical layers or less, 11 optical layers or less or 9 optical layers or less; and 3 optical layers or more, 5, 7, or 9 optical layers or more, may be needed. In select embodiments, 3 to 7 alternating layers are included whereas in other embodiments 9 or more alternating layers are included.

In many embodiments, the multilayer optical film is substantially planar, which provides specular behavior in the article when light is incident to the article.

In some embodiments, the multilayer optical film has a reflection spectrum at an incident light angle of 0° (e.g., normal incidence) that shifts to shorter wavelengths at oblique angles (e.g., 15°, 30°, 45°, 60°, or 75°). One can thus prepare a multilayer optical film having a normal incidence spectrum such that at an intended angle of incidence, the multilayer optical film reflects ultraviolet light in a range of 190 nm to 240 nm. Optionally, an intervening optical element (e.g., prism, louver, or the like) is placed between the multilayer optical film and a UVC light source to change or limit the angle of incidence of the light emitted by the UVC light source before it reaches an exterior surface of the multilayer optical film. Moreover, one can form a shape of an exterior surface of the multilayer optical film such that the angle of incidence is maintained for various locations of the multilayer optical film.

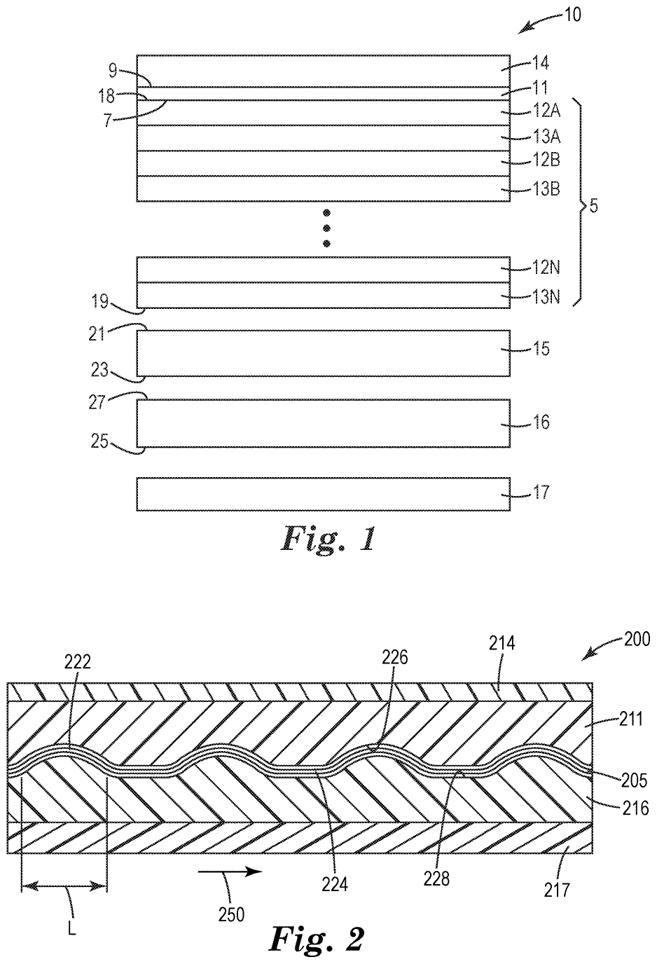

Referring to FIG. 1, a schematic cross-sectional view is provided of an exemplary article 10 including a first substrate 11 composed of a fluoropolymer having >10 to <55 mole % content of TFE; a multilayer optical film 5 disposed on a first major surface 7 of the first substrate 11; and a second substrate 14 composed of a fluoropolymer having >55 mole % content of TFE disposed on a second major surface 9 of the first substrate 11 opposite the multilayer optical film 5. The multilayer optical film 5 comprises first optical layers 12A, 12B, 12N, second optical layers 13A, 13B, 13N.

The multilayer article 10 optionally further comprises an acrylate layer 15 adjacent to the multilayer optical film 5, e.g., disposed on a major surface 19 of the multilayer optical film 5. In some embodiments, the acrylate layer can include an acrylate or an acrylamide. When the acrylate layer is to be formed by flash evaporation of the monomer, vapor deposition, followed by crosslinking, volatilizable acrylate and methacrylate (referred to herein as “(meth)acrylate”) or acrylamide or methacrylamide (referred to herein as “(meth)acrylamide”) monomers are useful, with volatilizable acrylate monomers being preferred. A suitable (meth)acrylate or (meth)acrylamide monomer has sufficient vapor pressure to be evaporated in an evaporator and condensed into a liquid or solid coating in a vapor coater. In certain embodiments, the acrylate layer is substantially transparent.

Examples of suitable monomers include, but are not limited to, hexanediol diacrylate; ethoxyethyl acrylate; cyanoethyl (mono)acrylate; isobornyl (meth)acrylate; octadecyl acrylate; isodecyl acrylate; lauryl acrylate; beta-carboxyethyl acrylate; tetrahydrofurfuryl acrylate; dinitrile acrylate; pentafluorophenyl acrylate; nitrophenyl acrylate; 2-phenoxyethyl (meth)acrylate; 2,2,2-trifluoromethyl (meth)acrylate; diethylene glycol diacrylate; triethylene glycol di(meth)acrylate; tripropylene glycol diacrylate; tetraethylene glycol diacrylate; neo-pentyl glycol diacrylate; propoxylated neopentyl glycol diacrylate; polyethylene glycol diacrylate; tetraethylene glycol diacrylate; bisphenol A epoxy diacrylate; 1,6-hexanediol dimethacrylate; trimethylol propane triacrylate; ethoxylated trimethylol propane triacrylate; propylated trimethylol propane triacrylate; tris(2-hydroxyethyl)-isocyanurate triacrylate; pentaerythritol triacrylate; phenylthioethyl acrylate; naphthloxyethyl acrylate; neopentyl glycol diacrylate, MIRAMER M210 (available from Miwon Specialty Chemical Co., Ltd., Korea), KAYARAD R-604 (available from Nippon Kayaku Co., Ltd., Tokyo, Japan), epoxy acrylate under the product number RDX80094 (available from RadCure Corp., Fairfield, N.J.); and mixtures thereof. A variety of other curable materials can be included in the polymer layer, such as, e.g., vinyl ethers, vinyl mapthalene, acrylonitrile, and mixtures thereof.

In particular, tricyclodecane dimethanol diacrylate is considered suitable. It is conveniently applied by, e.g., condensed organic coating followed by UV, electron beam, or plasma initiated free radical polymerization. A thickness between about 10 and 10000 nm is considered convenient, with approximately between about 10 and 5000 nm in thickness being considered particularly suitable. In some embodiments, thickness of organic layer can be between about 10 and 3000 nm.

It has been discovered that in articles having 9 or more alternating low/high refractive index layers, an acrylate layer can be present in the final article without the acrylate layer exhibiting significant degradation upon weathering of the article.

Referring again to FIG. 1, additional optional layers are also illustrated. For instance, the article 10 may further comprise a third substrate 16 disposed either on a major surface 19 of the multilayer optical film 5 opposite the first substrate 11 (not shown) or on a major surface 23 of the acrylate layer 15 opposite the multilayer optical film 5. The third substrate 16 is composed of a fluoropolymer having a >10 to <55 mole % content of TFE.

In some embodiments, the article 10 further comprises a fourth substrate 17 disposed on any of a major surface 25 of the third substrate 16 opposite the acrylate layer 15 when the third substrate is present (or opposite the multilayer optical film 5), on a major surface 19 of the multilayer optical film 5 opposite the first substrate 11 (not shown), or on a major surface 23 of the acrylate layer 15 opposite the multilayer optical film 5 (not shown). The fourth substrate is composed of glass or a fluoropolymer having a >55 mole % content of TFE.

In some embodiments, the article 10 further comprises an adhesive layer 17 disposed on a major surface 25 of the third substrate 16 opposite the acrylate layer 15 when the third substrate is present (opposite the multilayer optical film 5) or on a major surface of the multilayer optical film. Inclusion of an adhesive layer may be advantageous in affixing the article to another substrate, such as glass. The adhesive layer 17 comprises a silicone adhesive and may be a single layer of silicone or a multilayer silicone adhesive tape. For instance, suitable silicone adhesives are commercially available under the trade designations “3M Adhesive Transfer Tape 91022” (e.g., 2 mil thick clear roll) and “3M Adhesive Transfer Tape 96042”, both from 3M Company (St. Paul, MN).

In some embodiments, advantageously the multilayer optical film comprises buckling deformations and non-buckling regions that can function as a diffuse UVC light scatterer that may, for instance, enable better dispersion of UVC light throughout a designed space and destroy virions. Inorganic layers of multilayer optical films are susceptible to strain induced failure. Typically, when an inorganic oxide is exposed to conditions that induce more than 0.5% tensile strain, then the inorganic oxide will experience a multitude of in-plane fractures lowering its diffusion properties by orders of magnitude.

Referring now to FIG. 2, an exemplary article 200 including buckling deformations and non-buckling regions according to the present disclosure is illustrated. The article 200 includes a multilayer optical film 205 which has first 226 and second 228 opposing major surfaces. In the embodiment shown in FIG. 2, in direct contact with the first opposing major surface 226 of the multilayer optical film 205 is a first substrate 211 and a second substrate 214 is in direct contact with the first substate 211 opposite the multilayer optical film 205. Further, a third substrate 216 is in direct contact with the second opposing major surface 228 of the multilayer optical film 205, and a fourth substrate 217 is in direct contact with the third substrate 216 opposite the multilayer optical film 205.

The multilayer optical film 205 has buckling deformations 222 and non-buckling regions 224. In some embodiments, the buckling deformations may be irregular. Although as shown in FIG. 2, one buckling deformation 222 is followed by one non-buckling region 224, the number of buckling deformations between two adjacent non-buckling regions can be any number, for example, 1, 2, 3, 4, 5, etc. For example, in some embodiments, multiple continuous buckling deformations can be between two non-buckling regions. In some embodiments, multiple continuous buckling deformations can be followed by multiple continuous non-buckling regions. In some embodiments, non-buckling regions can be located at the end of the multilayer optical film 205. As shown in FIG. 2, the buckling deformations 222 have a length L. In some embodiments, the length L of the buckling deformations 222 may be no more than 400 nm, 300 nm, 200 nm, 100 nm, 50 nm, 40 nm, 30 nm, or no more than 20 nm. In some embodiments, the length L of buckling deformations 222 may be no less than 2 nm, 5 nm, 10 nm, or no less than 20 nm. The buckling deformations 222 may project along a first direction 250 as shown in FIG. 2. In some embodiments, the buckling deformations 222 may project along a second direction, which is different from the first direction 250. In some embodiments, the buckling deformations 222 may project along both the first direction and the second direction. In some embodiments, the first direction and the second direction can be mutually perpendicular to each other. For example, the first direction is along the x-axis of the barrier layer and the second direction is along the y-axis of the barrier layer. However, it should be appreciated that the first direction and the second direction can also be along other axes of the barrier layer. For example, if the multilayer optical film 205, when viewed from the top, is rectangular in shape, then first direction can be along a length of the rectangular surface and the second direction can be along the breadth of the rectangular surface.

The multilayer optical film 205 is characterized by buckling deformations 222 and non-buckling regions 224. Non-buckling regions, e.g., regions having substantially straight lines or substantially sharp edges, can provide technical benefits. For example, it is easy and convenient to make the multilayer optical film with non-buckling regions and thus reduces the manufacturing cost. In addition, by forming buckling deformations in multilayer optical film, which is described below, a pre-determined amount of compressive stress and additional surface area can be introduced into the multilayer optical film. In effect, the multilayer optical film builds up an amount of total surface area greater than the given projected two-dimensional area that is then unraveled when the multilayer optical film undergoes tensile strain. Therefore, when the multilayer optical film is stretched, the buckling deformations can alleviate stress and help the film elongate, thereby reducing strain induced failure. This allows the multilayer optical film of the present disclosure to bend in at least one direction in a plane along the surface of the multilayer optical film in reaction to at least one of thermal stress, mechanical stress, and load caused by deformation of an adjoining substrate or layer, thereby reducing build-up of the stress or the load and preventing the multilayer optical film from fracturing or cracking. The stress or the load can be a result of an outside force. The stress or the load can also be caused due to temperature variation in combination with different thermal expansion coefficients of multilayer optical film and adjoining layers. Further, the stress or the load can also be caused due to deformation of the adjoining layers. Also, the stress or the load can be caused due to humidity absorption and resulting expansion of the adjoining layers.

### Transfer Articles

In a second aspect, the present disclosure provides a transfer article. The transfer article comprises:
a) a release layer, wherein the release layer comprises a metal layer or a doped semiconductor layer;
b) an acrylate layer disposed on a major surface of the release layer; and
c) a multilayer optical film disposed on a major surface of the acrylate layer opposite the release layer, wherein the multilayer optical film is composed of alternating first and second layers of high refractive index material and low refractive index material, wherein the multilayer optical film transmits, at an incident light angle of at least one of 0°, 15°, 30°, 45°, 60°, or 75°, at least 30, 40, 50, 60, 70, 80, or 90 percent of incident light over at least a 30-nanometer wavelength bandwidth in a wavelength range from at least 400 nanometers to 700 nanometers.

The article illustrated in FIG. 1 may also be used to describe transfer articles according to the second aspect. For instance, referring to FIG. 1, a transfer article 10 includes a release layer 16 comprising a metal layer or a doped semiconductor layer: an acrylate layer 15 disposed on a major surface 27 of the release layer 16; and a multilayer optical film 5 disposed on a major surface 21 of the acrylate layer 15 opposite the release layer 16. The multilayer optical film and the acrylate layer are as described in detail above with respect to the first aspect.

The release layer 16 can include a metal layer. The metal layer may include at least one selected from the group consisting of individual metals, two or more metals as mixtures, inter-metallics or alloys, semi-metals or metalloids, metal oxides, metal and mixed metal oxides, metal and mixed metal fluorides, metal and mixed metal nitrides, metal and mixed metal carbides, metal and mixed metal carbonitrides, metal and mixed metal oxynitrides, metal and mixed metal borides, metal and mixed metal oxy borides, metal and mixed metal silicides, diamond-like carbon, diamond-like glass, graphene, and combinations thereof. In some embodiments, the metal layer may conveniently be formed of Al, Zr, Cu, NiCr, Ti, or Nb with thicknesses between 1 nm and 3000 nm.

Alternatively, the release layer 16 can include a doped semiconductor layer. In some embodiments, the doped semiconductor layer may conveniently be formed of Si, B-doped Si, Al-doped Si, P-doped Si with thicknesses between 1 nm and 3000 nm. A particularly suitable doped semiconductor layer is Al-doped Si, wherein the Al compositional percentage is 10%. The release layer can typically be prepared by evaporation, reactive evaporation, sputtering, reactive sputtering, chemical vapor deposition, plasma enhanced chemical vapor deposition, and atomic layer deposition. Preferred methods include vacuum preparations such as sputtering and evaporation. In at least certain embodiments according to the present disclosure, the transfer article exhibits a release value between the release layer 16 and the acrylate layer 15 from 2 to 50 grams per inch (g/in). Such a release value enables ready removal of the release layer 16 when it is desired to transfer the article to another substrate.

Referring again to FIG. 1, optionally the transfer article 10 includes a first substrate 11 composed of a fluoropolymer having >10 to <55 mole % content of TFE, in which the first substrate 11 is disposed on a first major surface 18 of the multilayer optical film 5 opposite the acrylate layer 15. In some embodiments, the transfer article 10 also includes a second substrate 14 disposed on a second major surface 9 of the first substrate 11 opposite the multilayer optical film 5, in which the second substrate 14 is composed of a fluoropolymer having >55 mole % content of TFE. The first and second substrates are as described in detail above with respect to the first aspect.

Another optional layer for a transfer article 10 includes a polymeric film 17 disposed on the release layer 16 opposite the acrylate layer 15. Exemplary suitable polymeric films include flexible transparent (co)polymeric films, optionally comprising polyethylene terephthalate (PET), polyethylene napthalate (PEN), heat stabilized PET, heat stabilized PEN, polyoxymethylene, polyvinylnaphthalene, polyetheretherketone, a fluoro (co)polymer, polycarbonate, polymethylmethacrylate, polyα-methyl styrene, polysulfone, polyphenylene oxide, polyetherimide, polyethersulfone, polyamideimide, polyimide, polyphthalamide, or combinations thereof.

### Methods

In a third aspect, the present disclosure provides a method of making an article. The method comprises:
obtaining a transfer article;
removing the release layer from the transfer article; and
laminating the multilayer optical film of the transfer article to a major surface of a third substrate comprised of a fluoropolymer having greater than 10 mole % content of TFE and less than 55 mole % content of TFE.

The transfer article is according to any of the embodiments of the second aspect, described in detail above.

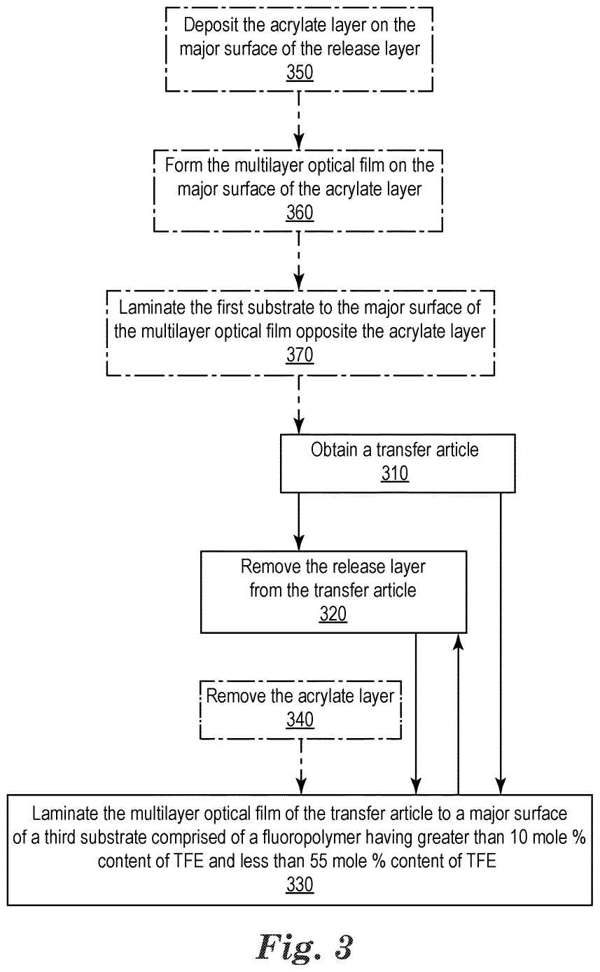

Referring to FIG. 3, a method of making an article comprises a step 310 to obtain a transfer article: a step 320 to remove the release layer from the transfer article; and a step 330 to laminate the multilayer optical film of the transfer article to a major surface of a third substrate comprised of a fluoropolymer having greater than 10 mole % content of TFE and less than 55 mole % content of TFE. As indicated by the arrows that point back and forth between the steps 310, 320, and 330, in certain embodiments, the laminating (330) is performed prior to the removing of the release layer (320).

Optionally, the method further comprises a step 340 to remove the acrylate layer from the (e.g., transfer) article prior to laminating the article to the second substrate. The acrylate layer is removed using etching. Suitable etching processes are not particularly limited and may include reactive ion etching or etching using any kind of plasma. In one embodiment, the acrylate layer is removed by reactive ion etching. Reactive ion etching (RIE) is a directional etching process utilizing ion bombardment to remove material. RIE systems are used to remove organic or inorganic material by etching surfaces orthogonal to the direction of the ion bombardment. The most notable difference between reactive ion etching and isotropic plasma etching is the etch direction. Reactive ion etching is characterized by a ratio of the vertical etch rate to the lateral etch rate which is greater than 1. Systems for reactive ion etching are built around a durable vacuum chamber. Before beginning the etching process, the chamber is evacuated to a base pressure lower than 1 Torr, 100 m Torr, 20 mTorr, 10 m Torr, or 1 m Torr. An electrode holds the materials to be treated and is electrically isolated from the vacuum chamber. The electrode may be a rotatable electrode in a cylindrical shape. A counter electrode is also provided within the chamber and may be comprised of the vacuum reactor walls. Gas comprising an etchant enters the chamber through a control valve. The process pressure is maintained by continuously evacuating chamber gases through a vacuum pump. The type of gas used varies depending on the etch process. Carbon tetrafluoride (CF₄), sulfur hexafluoride (SF₆), octafluoropropane (C₃F₈), fluoroform (CHF₃), boron trichloride (BCl₃), hydrogen bromide (HBr), chlorine, argon, and oxygen are commonly used for etching. RF power is applied to the electrode to generate a plasma. Samples can be conveyed on the electrode through plasma for a controlled time period to achieve a specified etch depth. Reactive ion etching is known in the art and further described in U.S. Pat. No. 8,460,568 (David et al.); incorporated herein by reference. The gas that is used to generate an etching plasma typically includes oxygen gas and a fluorocarbon (e.g., CF₄, C₂F₆, or C₃F₈). The molar concentration of fluorocarbon gas in the mixture is typically 0 to 60% depending upon the particular type of fluorocarbon and on the composition of the acrylate layer to be removed. Argon can also be a useful gas for plasma etching in combination with at least one of oxygen or a fluorocarbon. In some embodiments, oxygen alone is used to generate an etching plasma. Typically for plasma etching, power densities in the range from about 0.05 to about 1 watt/square cm (W/cm²) can be applied.

In select embodiments, the etching is performed at a power density of 0.11 W/cm² and the multilayer optical film is (e.g., remains) planar. It has been discovered, however, that when etching is performed at a higher power density, it can cause the multilayer optical film to distort from a planar major surface. More particularly, in select embodiments, the etching is performed at a power density of 0.25 W/cm² and imparts buckling deformations and non-buckling regions to the multilayer optical film. As discussed above with respect to FIG. 2, the presence of buckling deformations may provide UVC light scattering that is desirable in certain applications in which diffuse UVC light would be useful.

Referring again to FIG. 3, in some embodiments of the method, obtaining the transfer article comprises a step 350 to deposit the acrylate layer on the major surface of the release layer. Additionally, the method optionally further comprises a step 360 to form the multilayer optical film on the major surface of the acrylate layer. Another optional method step related to obtaining the transfer article is a step 370 to laminate the first substrate to the major surface of the multilayer optical film opposite the acrylate layer.

In certain embodiments, the transfer article comprises the optional first substrate and the optional second substrate, and the method further comprises coextruding the first substrate and the second substrate together. As mentioned above, coextruding the first substrate and the second substrate together tends to increase the strength of adhesion between the first substrate and the second substrate (e.g., as compared to heat laminating the first and second substrates to each other), preferably such that the first and second substrates exhibit a peel force of greater than 100 g/in peel force. Suitable first and second substrates are as described above with respect to the first aspect. In select embodiments, the first substrate comprises a 39 mole % content of TFE (e.g., “DYNEON THV 220” or “DYNEON THV 221”). In select embodiments, the second substrate comprises a 72.5 mole % content of TFE (e.g., “DYNEON THV 815”).

Advantageously, methods according to the present disclosure enable making an article having a multilayer optical film directly adhered to a fluoropolymer layer that has intact molecular weight and polymer entanglement architecture as a result of first preparing a transfer film in which instead of forming the multilayer optical film on the fluoropolymer layer, the multilayer optical film is formed on the major surface of the acrylate layer by sputter depositing alternating first and second layers of high refractive index material and low refractive index material, followed by transferring the multilayer optical film to the fluoropolymer layer. Avoiding directing the sputter depositing at the fluoropolymer layer prevents the fluoropolymer layer from experiencing damage, overheating, and/or wrinkling that could potentially occur during a sputter deposition process.

Moreover, the introduction of a transfer process provides a mechanism whereby an elastomeric first substrate can be allowed to relax and compress the multilayer optical film after transfer, thus generating compression-induced buckling patterns of the multilayer optical film analogous to those described in PCT Application Publication Nos. WO 2017/106078 (Gotrik et al.) and WO 2017/106107 (Gotrik et al.). This transforms an initially planar and specular UVC mirror into a diffuse UVC scatterer, which might better disperse throughout a designed space and destroy virions.

### EXEMPLARY EMBODIMENTS

In a first embodiment, the present disclosure provides an article. The article comprises a first substrate composed of a fluoropolymer having greater than 10 mole % content of tetrafluoroethylene (TFE) and less than 55 mole % content of TFE; a multilayer optical film disposed on a first major surface of the first substrate; and a second substrate disposed on a second major surface of the first substrate opposite the multilayer optical film, the second substrate composed of a fluoropolymer having greater than 55 mole % content of TFE. The multilayer optical film is composed of alternating first and second layers of high refractive index material and low refractive index material, wherein the multilayer optical film transmits, at an incident light angle of at least one of 0°, 15°, 30°, 45°, 60°, or 75°, at least 30, 40, 50, 60, 70, 80, or 90 percent of incident light over at least a 30-nanometer wavelength bandwidth in a wavelength range from at least 400 nanometers to 700 nanometers.

In a second embodiment, the present disclosure provides an article according to the first embodiment, further comprising a third substrate disposed on a major surface of the multilayer optical film opposite the first substrate, the third substrate composed of a fluoropolymer having a greater than 10 mole % content of TFE and less than 55 mole % content of TFE.

In a third embodiment, the present disclosure provides an article according to the first embodiment or the second embodiment, further comprising a fourth substrate disposed on a major surface of either the multilayer optical film or the third substrate opposite the multilayer optical film when the third substrate is present, wherein the fourth substrate is composed of glass or a fluoropolymer having a greater than 55 mole % content of TFE.

In a fourth embodiment, the present disclosure provides an article according to any of the first through third embodiments, wherein the multilayer optical film reflects, at an incident light angle of at least one of 0°, 15°, 30°, 45°, 60°, or 75°, at least 50, 60, 70, 80, 90, or 95 percent of incident light over a reflection wavelength bandwidth of at least 30 nm in a wavelength range from at least 190 nanometers to 320 nanometers.

In a fifth embodiment, the present disclosure provides an article according to any of the first through third embodiments, wherein the multilayer optical film transmits, at an incident light angle of at least one of 0°, 15°, 30°, 45°, 60°, or 75°, at least 80, 85, 90, or 95 percent of incident light over a wavelength bandwidth of at least 30 nm in a wavelength range from at least 190 nanometers to 240 nanometers and wherein the multilayer optical film reflects, at an incident light angle of at least one of 0°, 15°, 30°, 45°, 60°, or 75°, at least 50, 60, 70, 80, 90, or 95 percent of incident light over a reflection wavelength bandwidth of at least 30 nm in a wavelength range from at least 250 nanometers to 320 nanometers.

In a sixth embodiment, the present disclosure provides an article according to any of the first through third embodiments, wherein the multilayer optical film absorbs, at an incident light angle of at least one of 0°, 15°, 30°, 45°, 60°, or 75°, at least 50, 60, 70, 80, 90, or 95 percent of incident light over an absorption wavelength bandwidth of at least 30 nm in a wavelength range from at least 190 nanometers to 320 nanometers.

In a seventh embodiment, the present disclosure provides an article according to any of the first through third embodiments, wherein the multilayer optical film transmits, at an incident light angle of at least one of 0°, 15°, 30°, 45°, 60°, or 75°, at least 80, 85, 90, or 95 percent of incident light over a wavelength bandwidth of at least 30 nm in a wavelength range from at least 190 nanometers to 240 nanometers and wherein the multilayer optical film absorbs, at an incident light angle of at least one of 0°, 15°, 30°, 45°, 60°, or 75°, at least 50, 60, 70, 80, 90, or 95 percent of incident light over an absorption wavelength bandwidth of at least 30 nm in a wavelength range from at least 250 nanometers to 320 nanometers.

In an eighth embodiment, the present disclosure provides an article according to the sixth embodiment or the seventh embodiment, wherein the high refractive index material is composed of ZrOₓN_{y}, HfO₂, TiO₂, or ZnO and the low refractive index material composed of SiO₂, SiAlₓO_{y}, or MgF₂.

In a ninth embodiment, the present disclosure provides an article according to any of the first through fifth embodiments, wherein the high refractive index material is composed of ZrOₓN_{y}, HfO₂, or TiO₂, and the low refractive index material composed of SiAlₓO_{y}, SiO₂, or MgF₂.

In a tenth embodiment, the present disclosure provides an article according to any of the first through ninth embodiments, wherein the multilayer optical film comprises buckling deformations and non-buckling regions.

In an eleventh embodiment, the present disclosure provides an article according to any of the first through ninth embodiments, wherein the multilayer optical film is planar.

In a twelfth embodiment, the present disclosure provides an article according to any of the first through eleventh embodiments, wherein the multilayer optical film comprises 3 to 7 alternating layers.

In a thirteenth embodiment, the present disclosure provides an article according to any of the first through eleventh embodiments, wherein the multilayer optical film comprises 9 or more alternating layers.

In a fourteenth embodiment, the present disclosure provides an article according to the thirteenth embodiment, further comprising an acrylate layer disposed between the third substrate and the multilayer optical film.

In a fifteenth embodiment, the present disclosure provides an article according to any of the first through fourteenth embodiments, wherein the first substrate comprises THV.

In a sixteenth embodiment, the present disclosure provides an article according to any of the second through fifteenth embodiments, wherein at least one of the first substrate or the third substrate comprises a 39 mole % content of TFE.

In a seventeenth embodiment, the present disclosure provides an article according to any of the second through sixteenth embodiments, wherein at least one of the second substrate or the fourth substrate is present and comprises a 72.5 mole % content of TFE.

In an eighteenth embodiment, the present disclosure provides an article according to any of the first through seventeenth embodiments, wherein the first and second substrates exhibit a peel force of greater than 100 g/in peel force.

In a nineteenth embodiment, the present disclosure provides a transfer article. The transfer article comprises a release layer: an acrylate layer disposed on a major surface of the release layer; and a multilayer optical film disposed on a major surface of the acrylate layer opposite the release layer. The release layer comprises a metal layer or a doped semiconductor layer. The multilayer optical film is composed of alternating first and second layers of high refractive index material and low refractive index material, wherein the multilayer optical film transmits, at an incident light angle of at least one of 0°, 15°, 30°, 45°, 60°, or 75°, at least 30, 40, 50, 60, 70, 80, or 90 percent of incident light over at least a 30-nanometer wavelength bandwidth in a wavelength range from at least 400 nanometers to 700 nanometers.

In a twentieth embodiment, the present disclosure provides a transfer article according to the nineteenth embodiment, wherein the release layer comprises a metal layer comprising at least one selected from the group consisting of individual metals, two or more metals as mixtures, inter-metallics or alloys, semi-metals or metalloids, metal oxides, metal and mixed metal oxides, metal and mixed metal fluorides, metal and mixed metal nitrides, metal and mixed metal carbides, metal and mixed metal carbonitrides, metal and mixed metal oxynitrides, metal and mixed metal borides, metal and mixed metal oxy borides, metal and mixed metal silicides, diamond-like carbon, diamond-like glass, graphene, and combinations thereof.

In a twenty-first embodiment, the present disclosure provides a transfer article according to the nineteenth embodiment, wherein the release layer comprises a doped semiconductor layer formed of Si, B-doped Si, Al-doped Si, or P-doped Si.

In a twenty-second embodiment, the present disclosure provides a transfer article according to any of the nineteenth through twenty-first embodiments, wherein the acrylate layer is substantially transparent.

In a twenty-third embodiment, the present disclosure provides a transfer article according to any of the nineteenth through twenty-first embodiments, further comprising a first substrate composed of a fluoropolymer having greater than 10 mole % content of TFE and less than 55 mole % content of TFE, the first substrate disposed on a first major surface of the multilayer optical film opposite the acrylate layer.

In a twenty-fourth embodiment, the present disclosure provides a transfer article according to the twenty-third embodiment, further comprising a second substrate disposed on a second major surface of the first substrate opposite the multilayer optical film, the second substrate composed of a fluoropolymer having greater than 55 mole % content of TFE

In a twenty-fifth embodiment, the present disclosure provides a transfer article according to any of the nineteenth through twenty-fourth embodiments, further comprising a polymeric film disposed on the release layer opposite the acrylate layer.

In a twenty-sixth embodiment, the present disclosure provides a transfer article according to any of the nineteenth through twenty-fifth embodiments, exhibiting a release value between the release layer and the acrylate layer is from 2 to 50 grams per inch (g/in).

In a twenty-seventh embodiment, the present disclosure provides a method of making an article. The method comprises obtaining a transfer article according to any of the nineteenth through twenty-sixth embodiments: removing the release layer from the transfer article; and laminating the multilayer optical film of the transfer article to a major surface of a third substrate comprised of a fluoropolymer having greater than 10 mole % content of TFE and less than 55 mole % content of TFE.

In a twenty-eighth embodiment, the present disclosure provides a method according to the twenty-seventh embodiment, wherein the laminating is performed prior to the removing.

In a twenty-ninth embodiment, the present disclosure provides a method according to the twenty-seventh embodiment or the twenty-eighth embodiment, further comprising removing the acrylate layer from the article prior to laminating the article to the second substrate.

In a thirtieth embodiment, the present disclosure provides a method according to the twenty-ninth embodiment, wherein the acrylate layer is removed using etching.

In a thirty-first embodiment, the present disclosure provides a method according to the thirtieth embodiment, wherein the etching is performed at a power density of greater than 0.2 W/cm² and imparts buckling deformations and non-buckling regions to the multilayer optical film.

In a thirty-second embodiment, the present disclosure provides a method according to the thirtieth embodiment, wherein the etching is performed at a power density of less than 0.2 W/cm² and the multilayer optical film is planar.

In a thirty-third embodiment, the present disclosure provides a method according to any of the twenty-seventh through thirty-second embodiments, wherein the obtaining the transfer article comprises depositing the acrylate layer on the major surface of the release layer; and forming the multilayer optical film on the major surface of the acrylate layer.

In a thirty-fourth embodiment, the present disclosure provides a method according to the thirty-third embodiment, wherein the obtaining the transfer article further comprises laminating the first substrate to the major surface of the multilayer optical film opposite the acrylate layer.

In a thirty-fifth embodiment, the present disclosure provides a method according to any of the twenty-seventh through thirty-fourth embodiments, wherein the transfer article comprises the first substrate and the second substrate, wherein the method further comprising coextruding the first substrate and the second substrate together.

In a thirty-sixth embodiment, the present disclosure provides a method according to the thirty-fifth embodiment, wherein the second substrate comprises a 72.5 mole % content of TFE.

In a thirty-seventh embodiment, the present disclosure provides a method according to any of the twenty-seventh through thirty-sixth embodiments, wherein the transfer article comprises the first substrate and wherein the first substrate comprises a 39 mole % content of TFE.

In a thirty-eighth embodiment, the present disclosure provides a method according to the thirty-third embodiment, wherein the forming the multilayer optical film on the major surface of the acrylate layer comprises sputter depositing the alternating first and second layers of high refractive index material and low refractive index material.

In a thirty-ninth embodiment, the present disclosure provides an article according to any of the first through eighteenth embodiments, further comprising an adhesive layer disposed on a major surface of either the multilayer optical film or the third substrate opposite the multilayer optical film when the third substrate is present.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### EXAMPLES

Unless otherwise noted or otherwise apparent from the context, all parts, percentages, ratios, etc. in the Examples and the rest of the specification are by weight.

TABLE 2
Materials Used in the Examples

| Abbreviation | Description | Source |
|---|---|---|
| SR833 | tricyclodecane dimethanol diacrylate, | Sartomer Americas, Exton, PA, United |
| | under trade designation “SARTOMER | States |
| | SR833S” | |
| Zr | >99% purity | Protech Materials Inc, Hayward, CA, |
| | | United States |
| SiAl | Si(90%)/Al(10%) rotary sputtering | Soleras Advanced Coatings US, |
| | target | Biddeford, ME, United States |
| Cu | >99% purity | Protech Materials Inc, Hayward, CA, |
| | | United States |
| O₂ | Oxygen (UHP compressed gas) | Oxygen Service Company, St. Paul, MN, |
| | | United States |
| N₂ | Nitrogen (UHP compressed gas) | Oxygen Service Company, St. Paul, MN, |
| | | United States |
| Ar | Argon (UHP compressed gas) | Oxygen Service Company, St. Paul, MN, |
| | | United States |
| ST504 | Polyester film available under the trade | Du Pont Teijin Films, Chester, VA, |
| | designation “MELINEX ST504” | United States |
| Tape 8992 | High temperature polyester powder | 3M Company, St. Paul, MN, United |
| | coating masking tape, 2″ (5 cm) width, | States |
| | under trade designation “3M | |
| | POLYESTER TAPE 8992”. | |
| HfO₂ | EUDF hafnium oxide tablets, HfO₂, | Kurt J Lesker Co., Jefferson Hills, PA, |
| | 99.9% purity, 10-12 mm dia. × 4-5 mm | United States |
| | thick | |
| SiO₂ | Silicon dioxide pieces, 99.99% purity, | Kurt J Lesker Co., Jefferson Hills, PA, |
| | 1-5 mm pieces | United States |

### Test Method 1: Tape Adhesion Test

For this test, Tape 8992 was roll laminated at room temperature to the test surface of interest at 20 pounds/inch (about 3.6 kg/cm) lamination force at ambient temperature conditions. The tape was then removed, and the adhesive surface was analyzed visually for presence of colorful reflective material removed from the test surface or by use of Test Method 2.

### Test Method 2: UVC Reflectivity

Reflectance was measured on a PerkinElmer Lambda 1050 spectrometer (PerkinElmer, Inc., Waltham, MA) fitted with a 150 mm integrating sphere accessory at 61 wavelengths between 190-800 nm using standard PMT detector settings. A standard tungsten visible light source (PerkinElmer, Inc., Waltham, MA)) was used for the visible region and a deuterium light source (PerkinElmer, Inc., Waltham MA) was used for the ultraviolet region below 320 nm.

### Test Method 3: XPS

The sample surfaces of interest were examined using X-ray Photoelectron Spectroscopy (XPS) also known as Electron Spectroscopy for Chemical Analysis (ESCA) using the instrument and the test conditions described below. Note that this technique provides an analysis of the outermost 3 to 10 nanometers (nm) on the specimen surface. The photoelectron spectra provide information about the elemental and chemical (oxidation state and/or functional group) concentrations present on a solid surface. It is sensitive to all elements in the periodic table except hydrogen and helium with detection limits for most species in the 0.1 to 1 atomic % concentration range. XPS concentrations should be considered semi-quantitative unless standards are included in the data set.

TABLE 3
XPS Instrument and Test Conditions

| | |
|---|---|
| Instrument | Thermo Scientific Nexsa ™ (Thermo Fisher |
| | Scientific Inc., Waltham, MA) |
| analysis areas | » 400 μm (survey scans) |
| photoelectron take off angle | 90° ± 30° solid angle of acceptance |
| x-ray source | Monochromatic Al K α (1486.6 eV) 72 W |
| charge neutralization | Low energy e⁻ and Ar⁺ flood sources |
| charge correction | C—C/Hà284.8 eV |
| sputter ion gun conditions | Mono atomic Ar⁺ 2 KeV |
| | 2 × 2 mm raster (High 45 sec steps) |
| analysis chamber pressure | <5 × 10⁻⁷ mbar |

### Preparative Example 1: THV815/221

A multilayer polymeric film was made by coextruding a polypropylene first layer (available from under the trade designation pp 8650 from Atofina Chemicals, Inc., Crosby, TX) and a second layer also made with pp 8650, a polymer blend third layer comprising a 50:50 mixture of polyethylene methacrylate copolymer (available under the trade designation “ELVALOY 1125” from DOW Chemical Company, Midland, MI) with pp 8650 and a fluoropolymer fourth layer (available from 3M Company, St. Paul, MN under the trade designation “FLUOROPLASTIC GRANULES THV815GZ”) and a fluoropolymer fifth layer (obtained from 3M Company, St. Paul, MN under the trade designation “FLUOROPLASTIC GRANULES THV221GZ”) using a 5 layer multi-manifold die. The first and second layers were extruded into the 5-layer multi-manifold die with 25 mm twin screw extruders at 4.55 kg/hr. (10 lbs./hr.). The 50:50 pp 8650:ELVALOY 1125 polymer blend third layer was fed to the center manifold of the multi-manifold die with a 25 mm single screw extruder at 4.55 kg/hr. (10 lbs./hr.). The fluoropolymer THV815 fourth layer was fed to the multi-manifold die a with 25 mm twin screw extruders at 4.55 kg/hr. (10 lbs./hr.). The fluoropolymer THV221GZ fifth layer was fed to the multi-manifold die with a 31 mm single screw extruder at 4.55 kg/hr. (10 lbs./hr.). The multilayer polymeric film was cast onto a chilled roll at 5.54 meters/minute (18 fpm) to a thickness of 100 micrometers. After quenching and winding the multi-layer film into a roll that was 33 cm (13 inches) wide and 183 meters (200 yrds) long, the multi-layer film was unwound and 2.54 cm (1 inch) of multi-layer film were slit off both edges creating a 27.9 cm (11 inch) wide by 183 meters (200 yrds) long film roll.

### Preparative Example 2 (3-Layer UVC Transfer Film)

The UVC transfer film of this Example was made on a roll-to-roll vacuum coater similar to the coater described in U.S. Patent Application No. 2010/0316852 (Condo, et al.) with the addition of a second evaporator and curing system located between the plasma pretreatment station and the first sputtering system, and using evaporators as described in U.S. Pat. No. 8,658,248 (Anderson and Ramos). A 14″ (35.6 cm) wide roll of 0.003″ (0.08 mm) thick ST 454 PET film was loaded into the film winding system of the roll to roll (R2R) vacuum coating system and the chamber was pumped to the base pressure of 5×10⁻⁵ Torr (6.7×10⁻⁴ Pa).

The chamber gas pressure with the sputtering magnetron pair of two installed copper sputtering targets (Protech Materials Inc.; Hayward, CA) was adjusted with an Argon gas flow of 450 sccm to a pressure of 3.6 m Torr (0.48 Pa). Winding of the PET film roll was initiated and set to 6.75 feet per minute (fpm) (0.17 m/min). DC power was applied to the Advanced Energy DC Power Supplies of both copper-installed sputtering magnetrons and increased in stepwise fashion to 3.0 kW for each. A pre-sputtering period of ten minutes was used to achieve steady-state sputtering of copper. Upon reaching steady-state sputtering, online optical monitoring (tec5USA Inc., Plainview, NY) of spectral transmittance (0.71% transmittance at 550 nm WL) was used to estimate the sputtered copper layer thickness to be ˜85 nm. The film roll was sputtered upon with copper at this steady-state layer thickness for the length of the intended film roll sample-over the distance of 300 to 400 feet (91 to 122 m).

After reaching the final distance of the intended sample length, the sputter power was reduced to 0 and turned off. The film roll was wound in reverse to the origin location of 0 feet. A sputtering magnetron (E1), with installed sputtering target of titanium, was pre-set with 100 sccm nitrogen flow. A liquid monomer preparation of 10 ml of SR833 was degassed by vacuum pumping in a bell jar system, then evacuated and loaded into a syringe and installed to a syringe pump.

An evaporation chamber was heated to 250 degrees C. PET film movement was initiated at 5.0 fpm (1.5 m/min). The nitrogen plasma for titanium sputtering target was turned on to 20 W plasma setting for surface pretreatment of surface before monomer>polymer coating. The liquid monomer flow of SR833S was initiated at 1.0 ml/minute flow rate and, upon the flow reaching an ultrasonic atomizer at the entrance of the evaporation chamber (SonoTek US Inc., Islandia, NY), atomization was initiated by applying a power supply setting to 9.9 watts.

Atomized liquid monomer entered the heated evaporation chamber and “flash evaporated”, with the steady-state vapor exiting the chamber through an orifice of 0.150″ (0.38 cm) gap and 14″ (35.6 cm) width. The monomer vapor condensed onto the passing PET film and was subsequently cured by an electron beam source set to 7 k-volts & 7 mA-current. This produced a cured polymer film of 300 nm thickness. The steady-state polymer coating continued over the sample length from 300 to 400 feet (91 to 122 m), after which the monomer flow was stopped, atomization power was set to 0, and the evaporation chamber heating was turned off and allowed to cool to room temperature.

The film roll was wound in reverse to the origin location of 0 feet. The vacuum chamber pumping was closed off and the chamber was vented with nitrogen to atmospheric pressure. The two copper sputtering targets were replaced with two zirconium sputtering targets. Two additional zirconium sputtering targets were installed for a total of four installed zirconium sputtering targets. The vacuum chamber was closed and again vacuum pumped to the base pressure of 5×10⁻⁵ Torr (6.7×10⁻⁴ Pa). Argon sputtering gas was applied to the zirconium sputter targets (four total targets) at 375 sccm for each. Nitrogen and oxygen gas were applied to the zirconium sputter targets at 28 and 16 sccm, respectively, for each. Argon sputtering gas was applied to a rotary sputtering target pair (Gencoa Corp.; Biddeford, ME) of Silicon (90 wt. %) and Aluminum (10 wt. %) at 350 sccm. Winding of the PET film roll was initiated and set to 11.16 feet per minute (fpm) (about 3.5 m/min).

AC power (150 kHz frequency) was set to 3.0 kW for each zirconium target pair. The PET film was wound and sputtered upon with reactively sputtered ZrOₓN_{y} from 300 to 400 feet (91 to 122 m) of the film length, then reversed from 400 to 300 feet (91 to 122 m) and back and forth for a total of 5 machine passes, after which the sputtering power and the reactive nitrogen and oxygen gases are set to zero. These 5 machine passes produced a ZrOₓN_{y} layer thickness of 22.6 nm. Winding of the PET film roll was initiated and set to 12.76 feet per minute (fpm), now in reverse direction.

AC power was set to 22 kW for the Si—Al rotary target pair and, with oxygen gas flow regulated by the target voltage setting of 590 Volts, sputtering power was applied. This produced a sputtering plasma current of 42.5 amps, with an oxygen flow of 296 sccm. At the line speed setting of 12.76 fpm this produced a Si—Al—Oₓ layer thickness of 36.5 nm, after which the oxygen gas was set to zero and the AC power was shut off.

Upon completion, the film was advanced to the windup side, the chamber pumping was closed off and the chamber was vented to atmospheric pressure for film removal. The film was removed for off-line testing and the chamber was closed.

### Preparative Example 3 (5-Layer UVC Transfer Film)

The UVC transfer film of this Example was made as in Preparative Example 2, except an additional layer of Si—Al—Oₓ and an additional layer of ZrOₓN_{y} was deposited to increase the UVC mirror layer count of the multilayer optical film to 5.

Test Method 2 showed 60% reflectivity at 250 nm (UVC).

### Preparative Example 4 (7-Layer UVC Transfer Film)

The UVC transfer film of this Example was made as in Preparative Example 3, except an additional layer of Si—Al-Oₓ and an additional layer of ZrOₓN_{y} was deposited to increase the UVC mirror layer count of the multilayer optical film to 7.

Test Method 2 showed 70% reflectivity at 250 nm.

### Preparative Example 5 (19-Layer UVC Transfer Film)

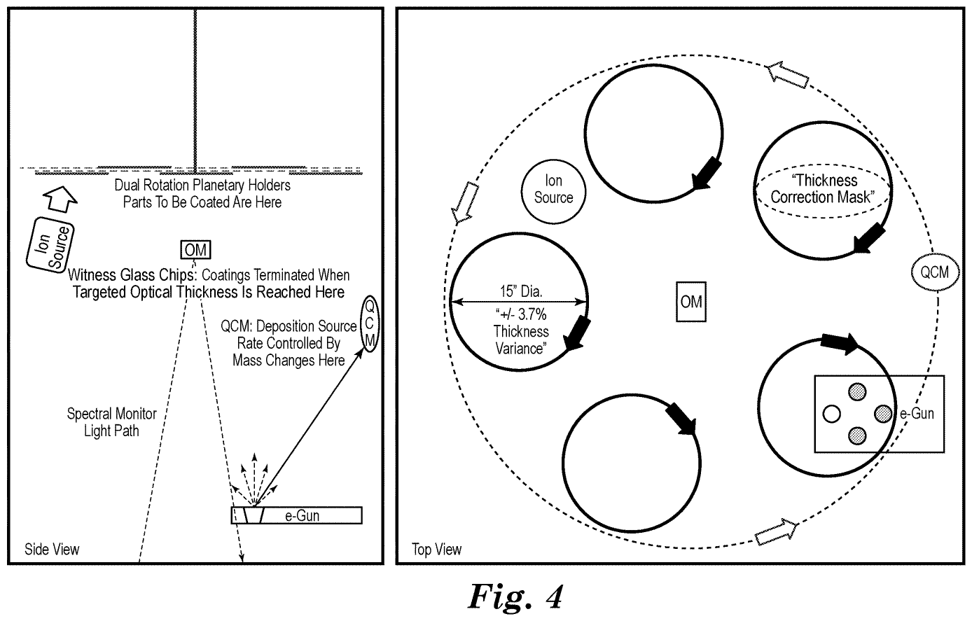

The UVC transfer film of this Example was made as in Preparative Example 3, except in place of the Si—Al—Oₓ and ZrOₓN_{y} sputtered layers, 19 evaporated layers were deposited on top of the SR833 layer using a vacuum coating system as described below. The vacuum coating system was equipped with a chamber, a high vacuum system, an ion source, an e-beam gun (e-gun) comprising graphite insert liners to hold four different target materials, dual rotation planetary holders, optical and quartz crystal monitors, and control system. The relative arrangement of the components of the coating system is schematically shown in FIG. 4.

As the 19-layered optical design uses approximately 62% SiO₂ and 38% HfO₂, and because SiO₂ is a “subliming” material (going directly to vapor state from solid state, without an intermediate melting state), three of the four available graphite insert liners on the e-gun were filled with SiO₂ granules and the fourth one with HfO₂ granules.

The substrate(s) to be coated were attached to each of the five planetary fixtures, and the fixtures were installed in the chamber. The remaining life of the quartz crystal was estimated and replaced, if necessary. Then the chamber door was closed, and the pump-down cycle initiated. Upon reaching the base pressure of 5×10⁻⁶ Torr (6.7×10⁻⁴ Pa), the planetary rotation was initiated. The chamber pressure was adjusted to 1×10⁻⁴ Torr (0.013 Pa) by allowing nitrogen into the chamber through a mass flow control (mfc) valve. Then the ion source was turned on and set to 200 Watts, allowing ten minutes of substrate surface treatment to improve adhesion to the substrate.

Next, the ion source was turned off and the nitrogen flow set to zero and the high vacuum valve was opened to allow chamber pressure return to base pressure of 5×10⁻⁶ Torr (6.7×10⁻⁴ Pa). The high voltage e-gun power supply was turned on and optical monitor (OM) and quartz crystal monitor (OCM) were initiated. With planetary rotation continuously on, the deposition controller was set to the pre-programmed process sequence for HfO₂ deposition. For layer 1, the coating thickness was set to 12.82 nm. The e-gun current raised through four steps of increasing power: Rise 1, Soak 1, Rise 2, Soak 2—at which point the evaporant was near evaporation temperature. Upon the end of Soak 2, the evaporant source shutter was opened, and the quartz crystal readout started indicating “real time” evaporation rate, as well as accumulated thickness. Upon reaching 12.82 nm layer thickness the evaporant source shutter was closed and e-gun current quickly returned to zero. After allowing a brief cooling period for the evaporant, the e-gun was rotated to the first SiO₂ hearth position. The SiO₂ deposition sequence was selected on the deposition controller to deposit SiO₂ to a thickness (layer 2) of 41.54 nm.

The SiO₂ deposition sequence proceeded similar to the previous HfO₂ deposition sequence after which the e-gun was returned to the HfO₂ hearth position. The HfO₂ and SiO₂ deposition sequence was alternated until the completion of the 19^{th} layer. The e-beam position was continuously monitored and adjusted during heating and deposition process to maintain steady evaporation rates and precision of the layer thickness and optical properties.

Upon completion of the last layer, the high voltage and e-gun power supply were turned down and close the pumping was stopped. The coating chamber was vented with nitrogen and the coated samples removed for measurement and analysis.

The Table 4, below, shows the resulting layer thicknesses (nm) for each of the 19 layers of the multilayer optical film.

TABLE 4
Layer Thicknesses

| | HfO₂-layer | SiO₂-layer |
|---|---|---|
| Layer | thickness (nm) | thickness (nm) |
| 19 | 5.45 | |
| 18 | | 63.16 |
| 17 | 9.64 | |
| 16 | | 17.27 |
| 15 | 10.38 | |
| 14 | | 34.8 |
| 13 | 25.12 | |
| 12 | | 41.5 |
| 11 | 24.14 | |
| 10 | | 44.68 |
| 9 | 26.37 | |
| 8 | | 36.26 |
| 7 | 34.11 | |
| 6 | | 29.31 |
| 5 | 35.63 | |
| 4 | | 33.07 |
| 3 | 27.06 | |
| 2 | | 41.54 nm |
| 1 | 12.82 nm | |

| | |
|---|---|
| 0 | SR833 |

Test Method 2 showed 95% reflectivity at 221 nm.

### Comparative Example 1

The Preparative Example 1 liner was removed and the THV815 surface was laminated to the ZrOₓN_{y} surface of Preparative Example 2 at 250° F. (about 121° C.). After cooling to room temperature, the Cu-coated PET liner of Preparative Example 2 was peeled away from the THV815 interface and no transfer of the UVC mirror was observed.

### Comparative Example 2

The Preparative Example 1 liner was removed and the THV815 surface was laminated to the ZrOₓN_{y} surface of Preparative Example 2 at 250° F. (about 121° C.); and immediately while hot, the Cu-coated PET liner of Preparative Example 2 was peeled away from the THV815 interface and transfer was observed on the THV815 surface. Test Method 1 was utilized on the first acrylate layer of Preparative Example 2 and the entire thin film construction was transferred to the tape leaving behind a pristine THV815 surface.

### Example 1

The Preparative Example 1 THV221 surface was laminated to the ZrOₓN_{y} surface of Preparative Example 2 at 250° F. (about 121° C.). After cooling to room temperature), the Cu-coated PET liner of Preparative Example 2 was peeled away from the THV221 interface and full transfer of the UVC mirror was observed. Test Method 1 was utilized on the freshly exposed first acrylate layer of Preparative Example 2 and the entire thin film construction remained on the THV221 surface. Test Method 2 was utilized measuring from the THV815 (removing the temporary liner construction facing THV815) side of the {THV815/THV221/UVC-mirror/SR833} construction and showed 50% reflectivity at 250 nm (UVC) and 85% transmission at 550 nm (visible light).

### Example 2

The Preparative Example 1 THV221 surface was laminated to the ZrOₓN_{y} surface of Preparative Example 3 at 250° F. (about 121° C.). After cooling to room temperature, the Cu-coated PET liner of Preparative Example 3 was peeled away from the THV221 interface and full transfer of the UVC mirror was observed. Test Method 1 was utilized on the freshly exposed first acrylate layer of Preparative Example 3 and the entire thin film construction remained on the THV221 surface. Test Method 2 was utilized measuring from the THV815 (removing the temporary liner construction facing THV815) side of the {THV815/THV221/UVC-mirror/SR833} construction and showed 60% reflectivity at 250 nm (UVC) and 89% transmission at 550 nm (visible light).

### Example 3

The Preparative Example 1 THV221 surface was laminated to the ZrON, surface of Preparative Example 4 at 250° F. (about 121° C.). After cooling to room temperature, the Cu-coated PET liner of Preparative Example 4 was peeled away from the THV221 interface and full transfer of the UVC mirror was observed. Test Method 1 was utilized on the freshly exposed first acrylate layer of Preparative Example 4 and the entire thin film construction remained on the THV221 surface. Test Method 2 was utilized measuring from the THV815 (removing the temporary liner construction facing THV815) side of the {THV815/THV221/UVC-mirror/SR833} construction and showed 70% reflectivity at 250 nm (UVC) and 91% transmission at 550 nm (visible light).

### Example 4

The Preparative Example 1 THV221 surface was laminated to the HfO₂ surface of Preparative Example 5 at 250° F. (about 121° C.). After cooling to room temperature, the Cu-coated PET liner of Preparative Example 4 was peeled away from the THV221 interface and full transfer of the UVC mirror was observed. Test Method 1 was utilized on the freshly exposed first acrylate layer of Preparative Example 4 and the entire thin film construction remained on the THV221 surface. Test Method 2 was utilized measuring from the THV815 (removing the temporary liner construction facing THV815) side of the {THV815/THV221/UVC-mirror/SR833} construction and showed 95% reflectivity at 221 nm (UVC) and 95% transmission at 550 nm (visible light).

### Comparative Example 3

The first acrylate layer of the {THV815/THV221/UVC-mirror/SR833} construction was exposed to an oxygen plasma using a home-built parallel plate capacitively coupled plasma reactor as described in U.S. Pat. No. 6,696,157 (David et al.). The chamber has a central cylindrical powered electrode with a surface area of 1.7 m² (18.3 ft²). After placing the film on the powered electrode, the reactor chamber was pumped down to a base pressure of less than 1.3 Pa (9.7 mTorr). O₂ gas was flowed into the chamber at a rate 1000 SCCM. Treatment was carried out using a plasma enhanced CVD method by coupling RF power into the reactor at a frequency of 13.56 MHz and an applied power of 4000 watts, resulting in a pressure of 8 mTorr (1 Pa). Treatment time was controlled by moving the film through the reaction zone at rate of 15 ft/min, resulting in an approximate exposure time of 20 seconds. At the end of this treatment time, the RF power and the gas supply were stopped and the chamber was returned to atmospheric pressure.

Visible cracking and distortion was observed in the UVC-mirror surface indicating the surface temperature of the THV221 was too high. This is undesirable due to exposure of THV in interstitial cracks to the reactive ion etching conditions.

### Example 4

The first acrylate layer of the {THV815/THV221/UVC-mirror/SR833} construction was exposed to an oxygen plasma using a home-built parallel plate capacitively coupled plasma reactor as described in U.S. Pat. No. 6,696,157 (David et al.). The chamber has a central cylindrical powered electrode with a surface area of 1.7 m² (18.3 ft²). After placing the film on the powered electrode, the reactor chamber was pumped down to a base pressure of less than 1.3 Pa (9.7 mTorr). O₂ gas was flowed into the chamber at a rate 4000 SCCM. Treatment was carried out using a plasma enhanced CVD method by coupling RF power into the reactor at a frequency of 13.56 MHz and an applied power of 2000 watts, resulting in a pressure of 39.9 mTorr (5.3 Pa). Treatment time was controlled by moving the film through the reaction zone at rate of 15 ft/min, resulting in an approximate exposure time of 20 seconds. At the end of this treatment time, the RF power and the gas supply were stopped and the chamber was returned to atmospheric pressure. The surface of the UVC mirror was pristine and glossy. XPS was completed and confirmed removal of the first acrylate layer.

### Example 5

The gloss surface of the first ZrOₓN_{y} deposited layer of the UVC mirror was exposed to impingement heating with a heat gun set at 300° F. (about 149° C.). After 1 minute the surface appeared hazy indicating surface structure for scattering. The wavelength of buckling was measured to be approximately 5 micrometers utilizing an optical microscope.

Foreseeable modifications and alterations of this invention will be apparent to those skilled in the art without departing from the scope and spirit of this invention. This invention should not be restricted to the embodiments that are set forth in this application for illustrative purposes.

1. An article comprising:
a) a first substrate composed of a fluoropolymer having greater than 10 mole % content of tetrafluoroethylene (TFE) and less than 55 mole % content of TFE;
b) a multilayer optical film disposed on a first major surface of the first substrate, wherein the multilayer optical film is composed of alternating first and second layers of high refractive index material and low refractive index material, wherein the multilayer optical film transmits, at an incident light angle of at least one of 0°, 15°, 30°, 45°, 60°, or 75°, at least 30, 40, 50, 60, 70, 80, or 90 percent of incident light over at least a 30-nanometer wavelength bandwidth in a wavelength range from at least 400 nanometers to 700 nanometers; and
c) a second substrate disposed on a second major surface of the first substrate opposite the multilayer optical film, the second substrate composed of a fluoropolymer having greater than 55 mole % content of TFE.

2. The article of claim 1, further comprising a third substrate disposed on a major surface of the multilayer optical film opposite the first substrate, the third substrate composed of a fluoropolymer having a greater than 10 mole % content of TFE and less than 55 mole % content of TFE.

3. The article of claim 1, further comprising a fourth substrate disposed on a major surface of either the multilayer optical film or the third substrate opposite the multilayer optical film when the third substrate is present, wherein the fourth substrate is composed of glass or a fluoropolymer having a greater than 55 mole % content of TFE.

4. The article of claim 1, wherein the multilayer optical film reflects, at an incident light angle of at least one of 0°, 15°, 30°, 45°, 60°, or 75°, at least 50, 60, 70, 80, 90, or 95 percent of incident light over a reflection wavelength bandwidth of at least 30 nm in a wavelength range from at least 190 nanometers to 320 nanometers.

5. The article of claim 1, wherein the multilayer optical film transmits, at an incident light angle of at least one of 0°, 15°, 30°, 45°, 60°, or 75°, at least 80, 85, 90, or 95 percent of incident light over a wavelength bandwidth of at least 30 nm in a wavelength range from at least 190 nanometers to 240 nanometers and wherein the multilayer optical film reflects, at an incident light angle of at least one of 0°, 15°, 30°, 45°, 60°, or 75°, at least 50, 60, 70, 80, 90, or 95 percent of incident light over a reflection wavelength bandwidth of at least 30 nm in a wavelength range from at least 250 nanometers to 320 nanometers.

6. The article of claim 1, wherein the multilayer optical film absorbs, at an incident light angle of at least one of 0°, 15°, 30°, 45°, 60°, or 75°, at least 50, 60, 70, 80, 90, or 95 percent of incident light over an absorption wavelength bandwidth of at least 30 nm in a wavelength range from at least 190 nanometers to 320 nanometers.

7. The article of claim 1, wherein the multilayer optical film transmits, at an incident light angle of at least one of 0°, 15°, 30°, 45°, 60°, or 75°, at least 80, 85, 90, or 95 percent of incident light over a wavelength bandwidth of at least 30 nm in a wavelength range from at least 190 nanometers to 240 nanometers and wherein the multilayer optical film absorbs, at an incident light angle of at least one of 0°, 15°, 30°, 45°, 60°, or 75°, at least 50, 60, 70, 80, 90, or 95 percent of incident light over an absorption wavelength bandwidth of at least 30 nm in a wavelength range from at least 250 nanometers to 320 nanometers.

8. The article of claim 6, wherein the high refractive index material is composed of ZrOₓN_{y}, HfO₂, TiO₂, or ZnO and the low refractive index material composed of SiO₂, SiAlₓO_{y}, or MgF₂.

9. The article of claim 1, wherein the multilayer optical film comprises buckling deformations and non-buckling regions.

10. The article of claim 1, wherein the multilayer optical film is planar.

11. The article of claim 1, wherein the multilayer optical film comprises 9 or more alternating layers.

12. The article of claim 11, further comprising an acrylate layer disposed between the third substrate and the multilayer optical film.

13. A transfer article comprising:
a) a release layer, wherein the release layer comprises a metal layer or a doped semiconductor layer;
b) an acrylate layer disposed on a major surface of the release layer; and
c) a multilayer optical film disposed on a major surface of the acrylate layer opposite the release layer, wherein the multilayer optical film is composed of alternating first and second layers of high refractive index material and low refractive index material, wherein the multilayer optical film transmits, at an incident light angle of at least one of 0°, 15°, 30°, 45°, 60°, or 75°, at least 30, 40, 50, 60, 70, 80, or 90 percent of incident light over at least a 30-nanometer wavelength bandwidth in a wavelength range from at least 400 nanometers to 700 nanometers.

14. The transfer article of claim 13, further comprising a first substrate composed of a fluoropolymer having greater than 10 mole % content of TFE and less than 55 mole % content of TFE, the first substrate disposed on a first major surface of the multilayer optical film opposite the acrylate layer.

15. The transfer article of claim 14, further comprising a second substrate disposed on a second major surface of the first substrate opposite the multilayer optical film, the second substrate composed of a fluoropolymer having greater than 55 mole % content of TFE.

16. A method of making an article, the method comprising:
obtaining a transfer article of claim 13;
removing the release layer from the transfer article; and
laminating the multilayer optical film of the transfer article to a major surface of a third substrate comprised of a fluoropolymer having greater than 10 mole % content of TFE and less than 55 mole % content of TFE.

17. The method of claim 16, further comprising removing the acrylate layer from the article prior to laminating the article to the second substrate.

18. The method of claim 17, wherein the acrylate layer is removed using etching and the etching is performed at a power density of greater than 0.2 W/cm² and imparts buckling deformations and non-buckling regions to the multilayer optical film.

19. The method of claim 17, wherein the acrylate layer is removed using etching and the etching is performed at a power density of less than 0.2 W/cm² and the multilayer optical film is planar.

20. The method of claim 17, wherein the transfer article comprises the first substrate and the second substrate, wherein the method further comprising coextruding the first substrate and the second substrate together.
